(19) United States
(12) Patent Application Publication
(10) Pub. No.: US 2013/0130579 A1
(43) Pub. Date: May 23, 2013

(54) SURFBOARD LEASH

(71) Applicants: Connell E. Nolan, Essex Junction, VT (US); Jeffrey M. Glass, Venice, CA (US)

(72) Inventors: Connell E. Nolan, Essex Junction, VT (US); Jeffrey M. Glass, Venice, CA (US)

(21) Appl. No.: 13/303,125

(22) Filed: Nov. 22, 2011

(51) Int. Cl. B63B 35/85; B23P 11/00; B23P 11/02; B63B 35/79

(52) U.S. Cl. 441/75; 29/428; 29/446

(57) ABSTRACT

A surfboard leash is provided including a first end configured to be mounted to a surfboard and a second end including a cuff to releasably couple the leash to a user (e.g., a surfer) of the surfboard. The cuff may include a board attachment structure for releasably coupling the cuff directly to the surfboard, for example for storage and/or transport of the surfboard. For example, the board attachment structure may include one or more suction cups disposed on an outer surface of the cuff.

### CROSS REFERENCE TO RELATED APPLICATIONS

The present application claims priority to U.S. Provisional Patent Application No. 61/419,980, filed Dec. 6, 2010, entitled “THE SURFBOARD LEECH, A SURFBOARD LEASH WITH SUCTION CUPS,” the entire disclosure of which is hereby incorporated by reference in its entirety.

### TECHNICAL FIELD

Embodiments herein relate to the field of surfboards, and, more specifically, to surfboard leashes.

### BACKGROUND

When surfing, stand-up paddle boarding (a form of surfing that also incorporates a paddle in the surfer's hands), boogie boarding, and the like, users (e.g., surfers) will often have a leash that will bind the surfer to their board. The leash typically includes a tether that is coupled to the surfboard at one end, and coupled to the surfer at the other end. The leash enables a surfer to locate their surfboard if they are separated from their board in the water. The leash also prevents the board from being swept away by waves and stops runaway boards from hitting other surfers, swimmers, and/or other objects.

When the surfboard is not in use the tether traditionally has been wrapped around the bottom of the board, adjacent the fins, in a coiled manner. Often the leash is coiled tightly around the end of the board and then the cuff is attached to the coiled leash. This method can lead to a number of potential hazards including damage to the rails (sides) of the surfboard (e.g., due to increased pressure of the tightly coiled leash), decreased life of the leash (e.g., due to kinks developed in the leash from the coiled tension), and/or possible injury to the surfer while attempting to secure the leash in the described method (e.g., the board and/or fins may strike the surfer while wrapping the leash as described above). Furthermore, the process of coiling the leash around the board may be strenuous and time consuming, and may not properly secure the leash to the board. Without properly securing the leash it will drag on the ground, causing further potential for hazards and/or a decreased life of the leash.

### BRIEF DESCRIPTION OF THE DRAWINGS

Embodiments will be readily understood by the following detailed description in conjunction with the accompanying drawings and the appended claims. Embodiments are illustrated by way of example and not by way of limitation in the figures of the accompanying drawings.

FIG. 1 illustrates a perspective view of a surfboard leash in accordance with various embodiments;

FIG. 2 illustrates a front view of the surfboard leash of FIG. 1 with a cuff of the surfboard leash coupled to a surfboard and a user carrying the surfboard;

FIG. 3 illustrates a cross sectional view of the cuff of FIG. 2 coupled to the surfboard in accordance with various embodiments;

FIG. 4A illustrates a perspective view of a surfboard leash with the cuff open, in accordance with various embodiments;

FIG. 4B illustrates a perspective view of the surfboard leash of FIG. 4A with the cuff closed;

FIG. 4C illustrates a partial left side view of the surfboard leash of FIG. 4A;

FIG. 4D illustrates a top view of the surfboard leash of FIG. 4A with the cuff open and laid out flat;

FIG. 4E illustrates a bottom view of the surfboard leash of FIG. 4A with the cuff open and laid out flat;

FIG. 4F illustrates a partial front view of the surfboard leash of FIG. 4A with the cuff open and laid out flat; and

FIG. 4G illustrates a perspective view of the surfboard leash of FIG. 4A coupled to a surfboard, in accordance with various embodiments.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “NB” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

In various embodiments, methods, apparatuses, and systems for a surfboard leash are provided. The surfboard leash may include an elongate tether having a first end and a second end. The surfboard leash may be coupled to a surfboard at or near the first end of the tether (e.g., at a first end of the surfboard leash). In some embodiments, the surfboard leash may include a mounting structure for coupling the first end of the tether to the surfboard. The leash may further include a cuff coupled to the tether at the second end of the tether (also referred to as the free end of the surfboard leash). The cuff may be configured to be releasably coupled to a user (e.g., a surfer) of the surfboard.

In various embodiments, the cuff may include a board attachment structure for releasably coupling the cuff directly to the surfboard (e.g., without any additional structure on the surfboard for receiving the cuff and/or tether). For example, in some embodiments, the board attachment structure may include one or more suction cups disposed on an outer surface of the cuff.

The board attachment structure may allow the cuff to be coupled to the surfboard when the surfboard is not in use (e.g., when the cuff is not coupled to the user). Accordingly, the board attachment structure may provide a quick and secure mechanism for coupling the free end of the surfboard leash to the surfboard. Among other benefits, this may facilitate transport and/or storage of the surfboard, and/or may allow the user to exit the water quickly and easily, thereby reducing the likelihood that the user will be struck by a wave, the leash, and/or the surfboard. Additionally, the board attachment structure may prevent/reduce damage to the surfboard leash that may otherwise occur from the leash dragging on the ground and/or being wrapped (coiled) around the surfboard. Furthermore, the board attachment structure may prevent/reduce damage to the surfboard, such as the sides (rails) of the surfboard, that may otherwise occur from wrapping the surfboard leash around the surfboard.

In various embodiments, the cuff may include any suitable structure for releasably coupling the free end of the surfboard leash to the user of the surfboard. For example, the cuff may have a substantially rectangular shape, and a first end portion of the cuff may be coupled with a second end portion of the cuff to form a loop. The cuff may be coupled around a portion of the user's body, such as at or near the ankle and/or wrist. In some embodiments, the first end of the cuff may be releasably coupled to the second end of the cuff by a releasable fastener, such as a hook and loop type fastener (e.g., Velcro™), one or more buttons, and/or one or more snaps. In other embodiments, the cuff may be permanently in a loop shape and may include an elastic component to facilitate coupling the cuff to the user's body.

In various embodiments, the mounting structure may include any suitable structure for coupling the first end of the tether to the surfboard. Similarly, the surfboard may include a receiving structure for receiving the mounting structure of the leash. For example, the surfboard may include an indentation on a first end portion (e.g., the foot) of the surfboard, commonly referred to as the leash cup. The leash cup may include a metal rod that is raised from the indentation. A piece of rope (e.g., nylon rope) may be coupled to the metal rod at one end, and include a loop at another end. The mounting structure may include a strap that may be releasably coupled to the loop in the rope. For example, the strap may include a hook and loop type fastener (e.g., Velcro™) to releasably couple the mounting structure to the rope.

In other embodiments, the mounting structure may be coupled directly to the metal rod of the surfboard. In yet other embodiments, the mounting structure may permanently and/or semi-permanently couple the surfboard leash to the surfboard.

In various embodiments, the board attachment structure may be disposed on a surface of the cuff to releasably couple the cuff directly to the surface of the surfboard. For example, in some embodiments, the board attachment structure may be coupled to an outer surface of the cuff (i.e., the surface of the cuff that faces outward from the user's body when the cuff is coupled to the user). In other embodiments, the board attachment structure may be coupled to an inner surface of the cuff (i.e., the surface of the cuff that faces the user's body when the cuff is coupled to the user). In some embodiments, the board attachment structure may allow the cuff to be coupled directly to the surface of the surfboard, without any additional structure on the surface of the surfboard to receive the cuff.

In use, the cuff may generally be coupled to the user's body (e.g., around the ankle) while the user is operating the surfboard (e.g., surfing). When the surfboard is not in use, the cuff may be uncoupled from the user's body and may be releasably coupled to the surfboard by the board attachment structure. The board attachment structure may allow the free end of the leash to be secured to the surfboard, thereby simplifying transport/storage and/or preventing the free end of the leash from dragging on the ground. Furthermore, the board attachment structure may allow the leash to be coupled relatively loosely to the surfboard, thereby reducing strain on the tether and/or preventing/reducing kinks in the tether. In some embodiments, the leash may be coupled lengthwise to the surfboard. For example, the first end of the tether may be coupled to the surfboard at a first end portion of the surfboard. The second end (free end) of the leash may be coupled to a second end portion of the surfboard, opposite the first end portion, by the board attachment structure of the cuff. This orientation may prevent/reduce damage to the surfboard and/or leash that may otherwise be caused by coiling the leash around the surfboard.

In some embodiments, the board attachment structure may include one or more suction cups coupled to the cuff. In some such embodiments, the board attachment structure may include a plurality of suction cups. In use, the suction cups may be coupled to the surface of the board by applying force to the suction cups, creating a pressure seal between a concave portion of the suction cups and the surface of the board. The pressure seal may be released by pulling on the suction cups, the cuff, and/or another part of the leash. In some embodiments, water may be present on the surfboard and/or suction cups that may facilitate the seal between the suction cups and the surfboard.

The board attachment structure may include any suitable quantity of suction cups, such as from about two to thirty suction cups, or, more specifically about four to eight suction cups. The suction cups may be arranged in any suitable arrangement and/or pattern on the surface of the cuff, such as in one or more rows and/or columns. For example, in one embodiment, the suction cups may be arranged in two rows oriented lengthwise on the outer surface of the cuff. In some embodiments, the suction cups may be disposed on only a portion of the surface of the cuff.

In various embodiments, the suction cups may have a diameter (e.g., a diameter of the concave portion of the suction cups). In some embodiments, the diameter of the suction cups may be about 0.1 inches to about two inches, such as about 0.25 inches to about one inch. In some embodiments, the diameter of the suction cups may be selected depending on how many suction cups are included, although any suitable combination of size and quantity is possible. The diameter may generally be less if more suction cups are included on the cuff. Having a plurality of smaller suction cups may allow the board attachment structure to have a relatively low profile (e.g., the suction cups may not stick out as much from the surface of the cuff) compared with a single larger suction cup, while still providing sufficient suction to secure the cuff to the surfboard. For example, the board attachment structure may include about two to six suction cups of about 0.5 inches to about one inch in diameter, such as about ⅝ inches in diameter. Alternatively, the board attachment structure may include about ten to about twenty-five suction cups of about 0.1 inches to about 0.5 inches in diameter, such as about 0.25 inches in diameter.

In various embodiments, the suction cups may be coupled to the surface of the cuff by any suitable means. For example, the suction cups may be coupled to the cuff by sewing/stitching, an adhesive, rivets, staples, and/or screws. In some embodiments, the suction cups may be attached to a backing material, and the backing material may be coupled to the cuff of the leash, such as by sewing/stitching, adhesive, rivets, staples and/or screws. In some embodiments, the suction cups may be disposed in holes in the backing material, and a rear portion of the suction cups may secure the suction cups in the holes.

In some embodiments, the suction cups and/or backing material may be releasably coupled to the cuff, such as by a hook and loop type fastener (e.g., Velcro). In some embodiments, the suction cups and/or backing material may be coupled to a conventional cuff that was not designed for use with the board attachment structure.

In various embodiments, the tether, cuff, and/or mounting structure may be made of any suitable materials. For example, the tether may be made from urethane. In some embodiments, the tether may include a cord, rope and/or a chain. In some embodiments, the cuff and/or mounting structure may include woven nylon, neoprene, and/or other suitable materials.

Although the surfboard leash has been discussed herein as being used for a surfboard, the surfboard leash may be used with any type of sport board, such as a surfboard, a boogie board, a skim board, a windsurfing board, and/or a skateboard.

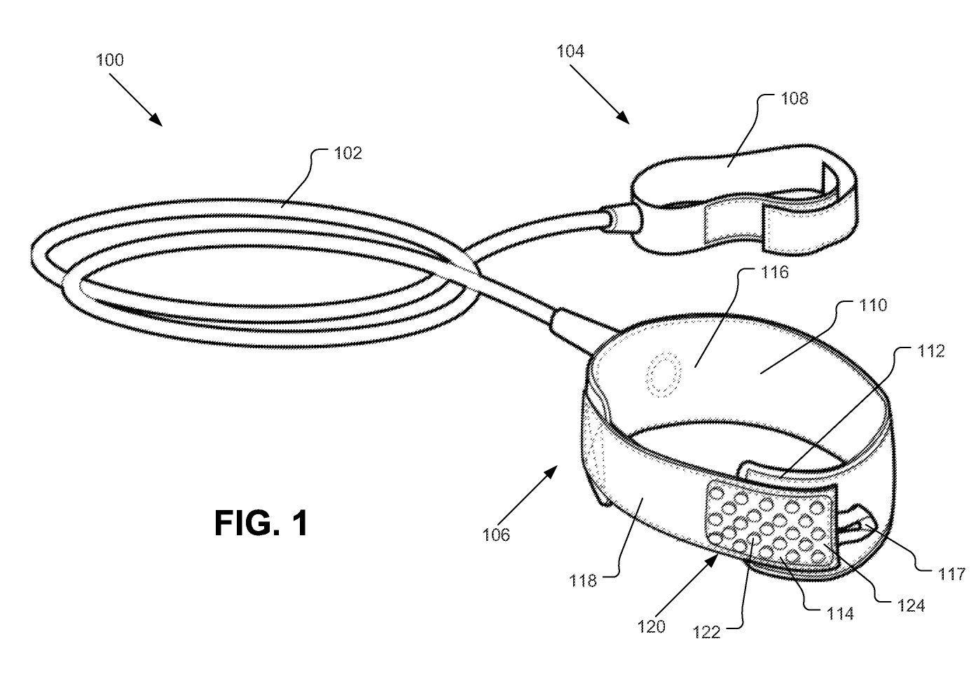

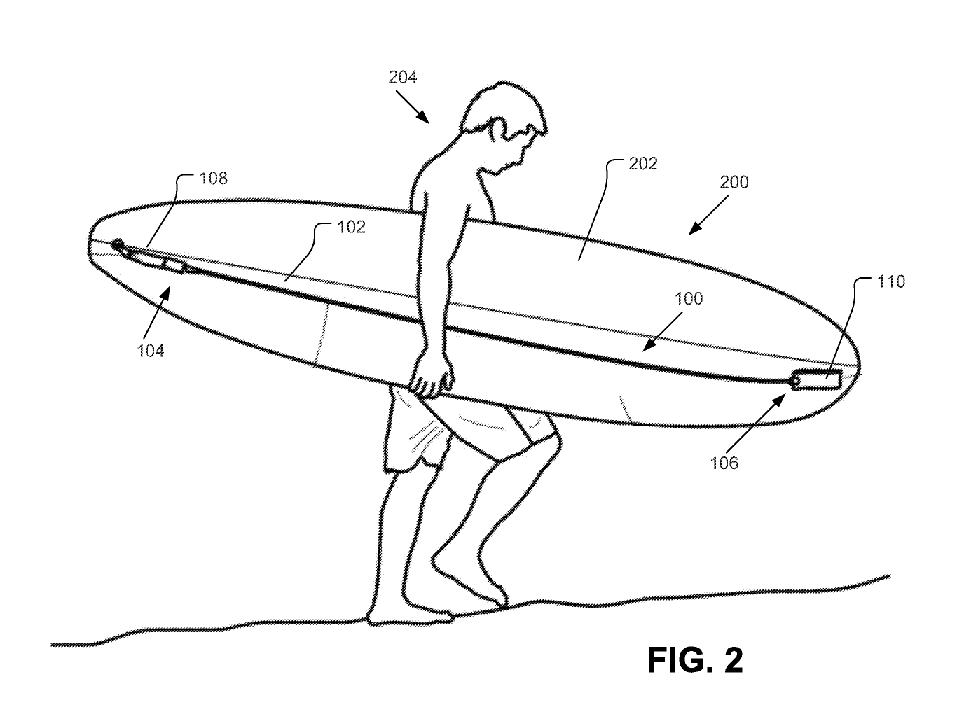

FIGS. 1-3 illustrate a surfboard leash 100, in accordance with various embodiments. The surfboard leash 100 includes a tether 102 disposed between a first end 104 and a second end 106 (also referred to as free end 106) of the surfboard leash 100. A mounting structure 108 is coupled to the tether 102 at the first end 104, and configured to be coupled to a surfboard 200 (as shown in FIG. 2). A cuff 110 is coupled to the tether 102 at the free end 106 of leash 100. A first end portion 112 of the cuff 110 may be releasably coupled to a second end portion 114 of the cuff by hook and loop type fasteners (e.g., Velcro™) to form a loop. In use, the cuff 110 may be coupled around the body of a user (e.g., surfer), such as around the ankle and/or wrist. When the cuff 110 is coupled to the user, an inner surface 116 faces the user's body, while an outer surface 118 faces outward from the user's body. A tab 117 extends from the second end portion 114 to facilitate uncoupling the second end portion 114 from the first end portion 112 of the cuff 110 (e.g., when removing the cuff 110 from the user's body).

A board attachment structure 120 is coupled to the outer surface 118 of cuff 110, and includes a plurality of suction cups 122. Suction cups 122 are coupled to a backing material 124, and the backing material 124 is stitched to the outer surface 118 of cuff 110. Board attachment structure 120 includes twenty three suction cups 122 arranged on cuff 110. Other embodiments may include any suitable quantity and/or arrangement of suction cups 122 on cuff 110.

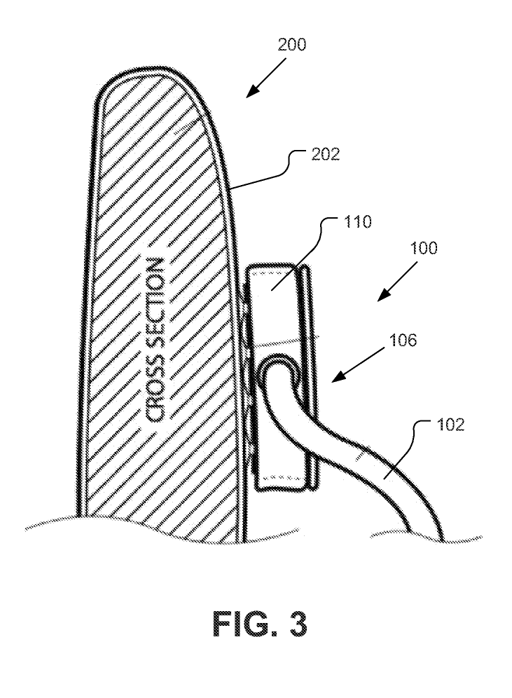

The suction cups 122 may be releasably coupled to a surface 202 of surfboard 200, as shown in FIGS. 2 and 3, to couple the free end 106 of leash 100 to the surfboard 200. FIG. 2 shows the free end 106 coupled to the surfboard 200 while the surfboard is being transported by a user 204. The board attachment structure 120 of leash 100 may provide a mechanism for quickly and conveniently releasably coupling the free end 106 of leash 100 to the surfboard 200, thereby facilitating transport and/or storage of the surfboard 200 while preventing/reducing damage to leash 100. The board attachment structure 120 may couple the free end 106 of leash 100 directly to the surface 202 of surfboard 200 without any additional structure mounted on the surface 202.

As shown in FIG. 2, in some embodiments, the first end 104 of leash 100 may be coupled to a first end portion 204 of surfboard 200, and the suction cups 122 may couple the free end 106 of the leash 100 to a second end portion 206 of surfboard 200. This orientation may prevent/reduce damage to the surfboard 200 and/or leash 100 that may otherwise be caused by coiling the leash 100 around the surfboard 200. In other embodiments, the free end 106 of the leash 100 may be coupled to any suitable portion of the surface 202 of surfboard 200.

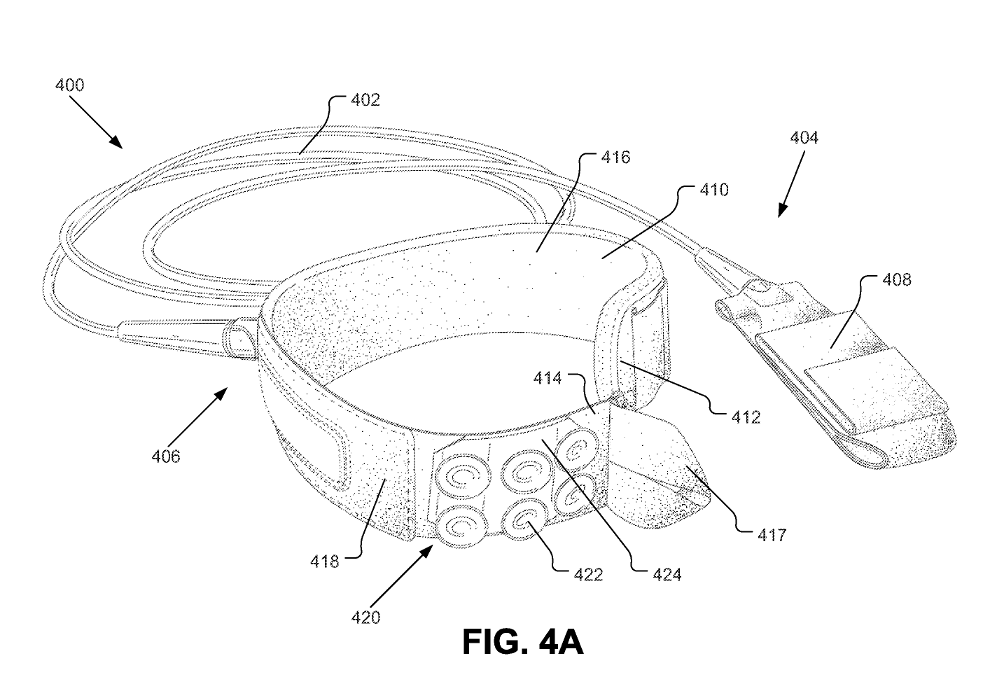

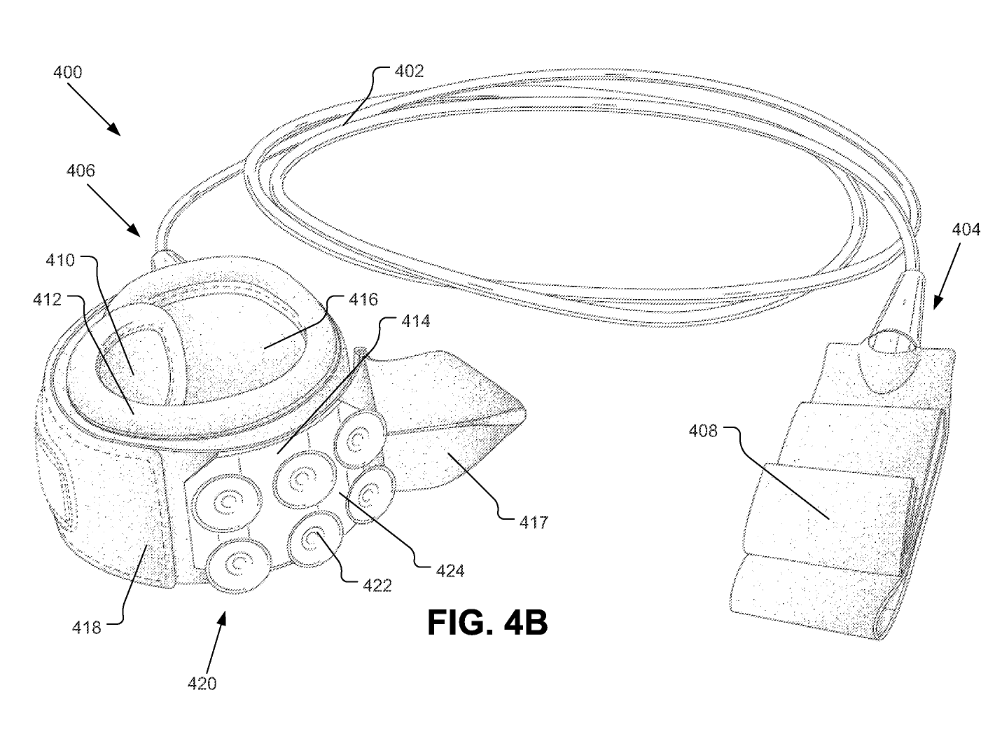

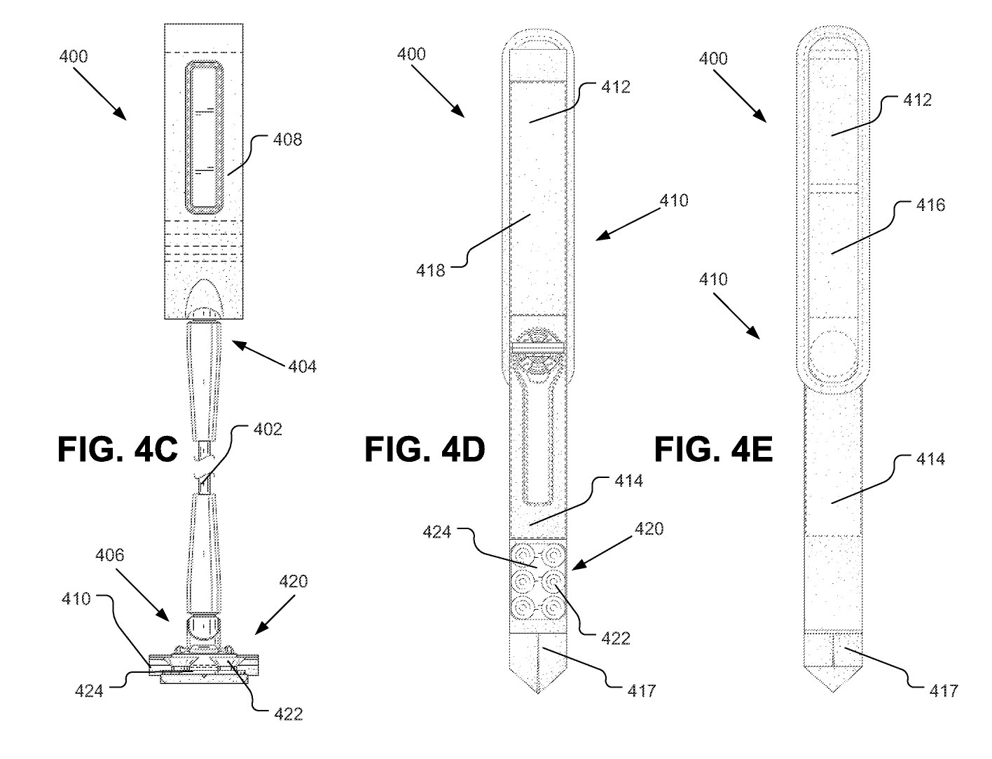

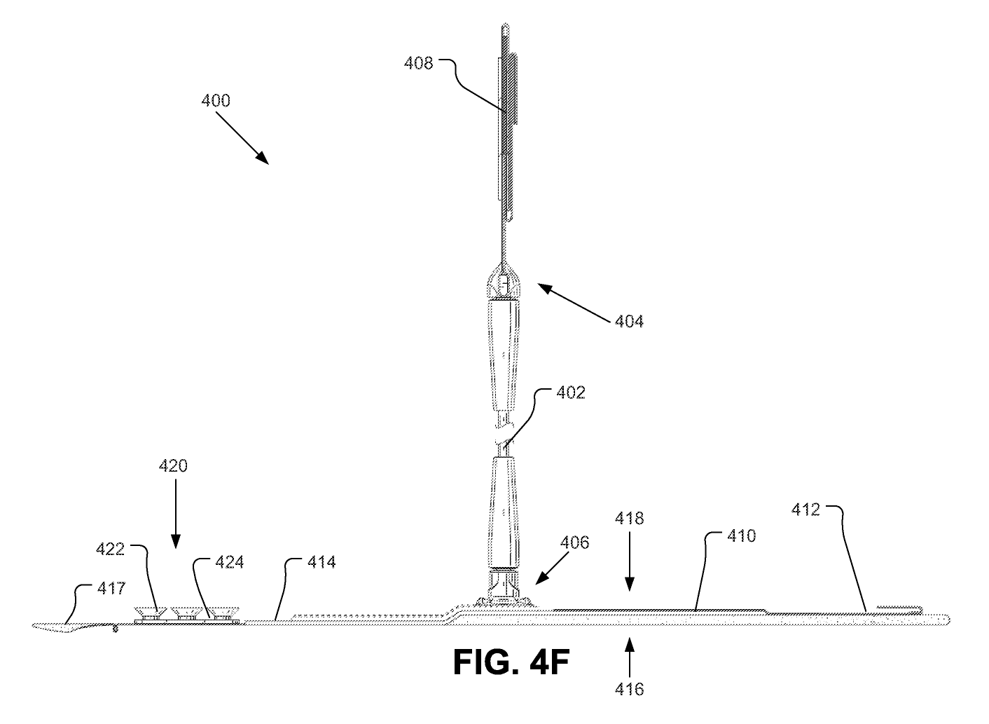

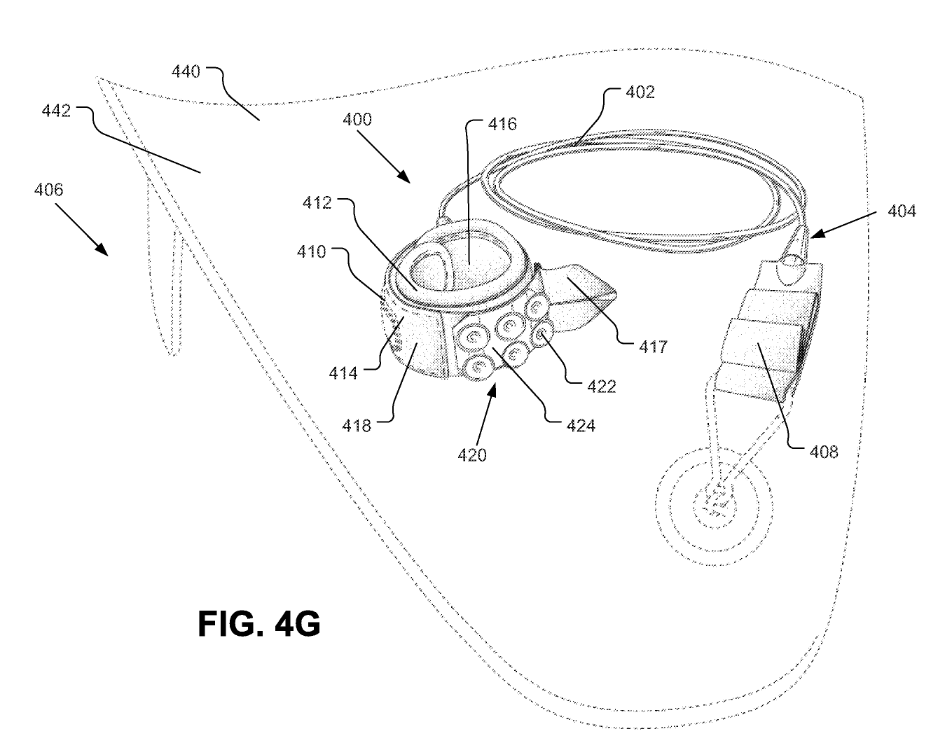

FIGS. 4A-G show another example of a surfboard leash 400, in accordance with various embodiments. Surfboard leash 400 includes a tether 402 disposed between a first end 404 and a second end 406 (i.e., free end 406) of the surfboard leash 400. A mounting structure 408 is coupled to the tether 402 at the first end 404, and configured to be coupled to a surfboard 440 (as shown in FIG. 4G). A cuff 410 is coupled to the tether 402 at the free end 406 of leash 400. A first end portion 412 of the cuff 410 may be releasably coupled to a second end portion 414 of the cuff by hook and loop type fasteners (e.g., Velcro™) to form a loop (as shown in FIGS. 4B and 4G). In use, the cuff 410 may be coupled around the body of a user (e.g., surfer), such as around the ankle and/or wrist. When the cuff 410 is coupled to the user, an inner surface 416 faces the user's body, while an outer surface 418 faces outward from the user's body. A tab 417 extends from the second end portion 414 to facilitate uncoupling the second end portion 414 from the first end portion 412 of the cuff 410 (e.g., when removing the cuff 410 from the user's body).

Leash 400 includes a board attachment structure 420 coupled to the outer surface 418 of the cuff 410. Board attachment structure 420 includes six suction cups 422. Suction cups 422 may be used to releasably couple the cuff 410 directly to a surface 442 of surfboard 440.

As shown in FIGS. 4A-G, the suction cups 422 are arranged in two rows oriented lengthwise on the outer surface of cuff 410. Other embodiments may include any suitable quantity and/or arrangement of suction cups 422.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. A surfboard leash, comprising:
an elongate tether having a first end and a second end, the first end configured to be coupled to a surfboard;
a cuff coupled to the tether at the second end and configured to be releasably coupled to a user of the surfboard;
a board attachment structure disposed on a surface of the cuff and configured to be releasably coupled directly to a surface of the surfboard.

2. The surfboard leash of claim 1, wherein the board attachment structure includes one or more suction cups.

3. The surfboard leash of claim 2, wherein the board attachment structure includes a plurality of suction cups arranged in two rows on the surface of the cuff.

4. The surfboard leash of claim 2, wherein the one or more suction cups are permanently coupled to a backing material, and the backing material is coupled to the surface of the cuff.

5. The surfboard leash of claim 1, wherein the surface of the cuff on which the board attachment structure is disposed comprises an outer surface that faces away from the user when the cuff is coupled to the user.

6. The surfboard leash of claim 1, wherein a diameter of a concave portion of the suction cups is about 0.1 inches to about two inches.

7. The surfboard leash of claim 1, further comprising a mounting structure coupled to the first end of the tether to releasably couple the first end of the tether to the surfboard.

8. A method comprising:
coupling a surfboard leash to a first end portion of a surfboard, the surfboard leash including a tether and a cuff coupled to the tether at a free end of the surfboard leash, the cuff configured to be releasably coupled to a user of the surfboard;
releasably coupling the cuff directly to a surface of the surfboard by a board attachment structure disposed on a surface of the cuff.

9. The method of claim 8, wherein the cuff is releasably coupled to a second end portion of the surfboard, the second end portion opposite the first end portion.

10. The method of claim 8, wherein the board attachment structure includes one or more suction cups.

11. The surfboard leash of claim 10, wherein the board attachment structure includes from two to twenty suction cups.

12. The surfboard leash of claim 10, wherein the one or more suction cups are permanently coupled to a backing material, and the backing material is permanently coupled to the outer surface of the cuff.

13. The surfboard leash of claim 8, wherein the surface of the cuff on which the board attachment structure is disposed comprises an outer surface that faces away from the user when the cuff is coupled to the user.

14. A system comprising:
a surfboard;
a surfboard leash having a first end and a second end, the first end coupled to the surfboard;
a cuff disposed on the second end of the surfboard leash and configured to be releasably coupled to a user of the surfboard;
one or more suction cups disposed on the cuff and configured to releasably couple the cuff directly to a surface of the surfboard.

15. The system of claim 14, wherein the one or more suction cups comprise a plurality of suction cups.

16. The system of claim 15, wherein the plurality of suction cups are arranged in two rows oriented lengthwise on the cuff.

17. The system of claim 16, wherein the plurality of suction cups each have a diameter of about 0.25 inch to about one inch.

18. The system of claim 15, wherein the plurality of suction cups are permanently coupled to a backing material, and the backing material is coupled to the outer surface of the cuff.

19. The system of claim 14, wherein the one or more suction cups are coupled to an outer surface that faces away from the user when the cuff is coupled to the user.
